(19) United States
(12) Patent Application Publication
(10) Pub. No.: US 2024/0043119 A1
(43) Pub. Date: Feb. 8, 2024

(54) BRACKET

(71) Applicant: Zodiac Cabin Controls GmbH, Hamburg (DE)

(72) Inventors: Klaas Blume, Hamburg (DE); Torsten Kuehnert, Hamburg (DE); Erasmo Benna, Hamburg (DE); Edwin Van Der Perk, Hamburg (DE)

(21) Appl. No.: 18/229,432

(22) Filed: Aug. 2, 2023

(30) Foreign Application Priority Data
Aug. 3, 2022 (EP) 22188593.2

(51) Int. Cl. B64D 11/02; E03C 1/04

(52) U.S. Cl. CPC B64D 11/02; E03C 1/0402

(57) ABSTRACT

The present invention provides a fixing system to connect, install, mount and/or fix a device or an equipment to a structure or a structural environment such as, for example, an aircraft structure, through at least one first fixing means and at least one second fixing means. Furthermore, the present invention relates to a method for using such a fixing system in a method for connecting, installing, mounting and/or fixing a device or an equipment to a structure or a structural environment such as, for example, an aircraft structure to a structure of the aircraft and to a device.

The fixing system can be a bracket.

The fixing system comprises at least one first fixing means to connect a structure or a structural environment to the fixing system and at least one second fixing means to connect a device or an equipment to the fixing system.

### CROSS REFERENCE TO RELATED APPLICATIONS

This application is related to and claims priority benefits from Europe Patent Application No. 22188593.2 (“the '932 application”), filed on Aug. 3, 2022, entitled BRACKET. The '932 application is hereby incorporated in its entirety by this reference.

### TECHNICAL FIELD

The present invention relates to a fixing system to connect, install, mount and/or fix a device or an equipment to a structure or a structural environment such as, for example, an aircraft structure, through at least one first fixing means and at least one second fixing means. Furthermore, the present invention relates to a method for using such a fixing system in a method for connecting, installing, mounting and/or fixing a device or an equipment to a structure or a structural environment such as, for example, an aircraft structure to a structure of the aircraft and to a device.

The fixing system can be a bracket.

One specific application of the invention could be in connecting, installing, mounting and/or fixing a faucet or a soap dispenser to a countertop in an aircraft lavatory.

### BACKGROUND ART

Currently there are three different mounting systems for a device or an equipment available. These known mounting systems are described below for exemplary water faucets.

In the first prior art system shown in FIG. 10, a structure and/or countertop 1 provides at least two threaded inserts 9, in which a bracket 2 is fixed by at least two screws 3. This bracket 2 is used to install and fix a faucet 4. The respective bracket 2 belongs together with the respective faucet 4 and they are normally delivered within one assembly (one part number).

In the second prior art system shown in FIG. 11, a countertop 5 provides two bolts 6, which also serve as hydraulic interface. A water faucet 7 will be put on these bolts 6 and secured with a bracket comprising at least two screws 8 or with at least two screws (not shown in FIG. 11), which grip into two undercuts in the bolts 6.

The third prior art system is a combination of the first and second systems, where a plate with two bolts is fixed to a countertop by screws.

Further, in immobile structures such as, for example, lavatories or kitchens in buildings, houses or flats where enough space is available and/or where a quick exchange of the device or equipment in a limited short amount of time is not required, devices or equipment such as faucets are fixed from the back side of the structure.

### Problems Associated with the Prior Art

All existing systems in the prior art with limited space have at least one severe and crucial disadvantage in that the hole pattern of the device or equipment such as a faucet has to match exactly to the hole pattern of the structure such as, for example, an aircraft structure such as, for example, a lavatory structure which could be a countertop, for example. Hereby, different structural environments such as, for example, lavatories, for different aircraft classes often also have different hole patterns in the structure such as, for example, an aircraft structure which could be a countertop in a lavatory, for example. If there should occur differing hole patterns in different structures, it would not be possible to install the same device or equipment such as, for example, a specific faucet in different structures such as, for example, different aircraft structures such as, for example, countertops in a lavatory. A specific device or equipment has to be constructed for every specific corresponding structure.

This disadvantage is not limited to faucets and also not limited to aircrafts and/or aircraft structures but generally occurs in devices or equipment that should be connected, installed, mounted and/or fixed to a structure or a structural environment with a hole pattern because the hole pattern in any device or equipment that should be connected, installed, mounted and/or fixed to a structure has to match exactly to the hole pattern of said structure.

Fixing systems in immobile structures may be installed through one hole of sufficient size but hereby the device or equipment is fixed from the back side because there are normally no space or weight restrictions and/or no requirements for a quick exchange of the device or equipment in a limited short amount of time.

### Technical Objectives of the Invention

The main technical problems to be solved by the present invention are:
1) In many structural environments, space for structures and devices or equipment is getting more and more reduced, which leads to geometrical and environment design constraints.
   For example, modern aircraft lavatories are getting more and more space reduced, for example, for gaining more seats and more paying passengers, which leads to reducing space such as for a washbasin space envelope resulting in device or equipment geometrical and environmental design constraints such as, for example, faucet geometrical and environment design constrains.
2) Harmonization of the fixing system. The present invention discloses a fixing concept to find, for example, a common mounting bracket concept for devices or equipment to be installed in various different structures or structural environments without any adapter parts.
3) Optimized and easy installation of devices or equipment to structures or structural environments.

### SUMMARY OF THE INVENTION

The purpose of this invention is a fixing concept for any device or equipment installed on any kind of structure or structural environment such as, for example, an aircraft structure such as, for example, a lavatory, such as, for example, a faucet or a soap dispenser to a countertop in an aircraft lavatory to enable minimum space usages and realizing maximum flexibility regarding different structural environments without the need for a dedicated adapter.

The universal fixing concept possibly in form of a fixing system possibly in form of a universal mounting bracket can be applied in any structural environment to enable installation of an appropriate device or equipment.

A structure can be of any kind to which a device or an equipment could be connected, installed, mounted and/or fixed to, such as transport vehicles such as, for example, aircraft, trains, busses, trucks, ships or cars, more particularly, passenger transport vehicles for passenger transportation such as, for example, passenger aircraft, passenger trains, passenger busses, passenger trucks, passenger ships or passenger cars, even more particularly, respective lavatories, cabins, galleys and/or kitchenettes on said passenger transport vehicles such as, for example, a lavatory, a cabin and/or a galley of an aircraft, a lavatory, a cabin, a galley and/or a kitchenette of a train, a lavatory, a cabin, a galley and/or a kitchenette on a bus, a lavatory, a cabin, a galley and/or a kitchenette on a truck, a lavatory, a cabin, a galley and/or a kitchenette on a ship or lavatory, a cabin, a galley and/or a kitchenette of a RV (recreational vehicle).

The structure can also be any kind of building, house, flat or immobile installation, such as a lavatory, a cabin, a galley and/or a kitchenette thereof.

Examples for a device or equipment are touchless, pushbutton, mechanical, electromechanical faucets, soap dispensers or water dispensers in a lavatory or galley compartment, or disinfection dispensers with a location in the aircraft cabin.

An example for a structural environment is an aircraft structure.

An example for an aircraft structure is a countertop, where said countertop can be located in an aircraft lavatory.

The terms “device” and “equipment” are used interchangeably, their meaning, however, is understood in the normal way of each word and they are not synonyms. The terms “structure” and “structural environment” are also used interchangeably, their meaning, however, is understood in the normal way of each word and they are not synonyms.

Several goals are achieved by the present invention:
Installation independent from the wall thickness of the structure.
Independence from structural pre-defined interfaces.
Interfaces such as, for example, electrical and/or hydraulically interfaces, can be integrated in the fixing concept.
Independence of the fixing concept from the equipment part.
Mounting from the front side without visible fixing points.
Fixation on the back side of the structural environment.
Possibility to fix an equipment in several different structural environments.
Independent of the thickness and pre-defined interfaces.
No visible fixing means which need to be covered and/or sealed.
The at least one connection such as, for example, a hydraulic connection and/or an electrical connection as well as the fastening of the equipment are integrated in the fixing concept, which reduces the size needed.
Quick installation and de-installation of the equipment possible.
With simple and reduced fixing means such as, for example, one screw fixation, improved finishing and appearance and less susceptibility for pollution may be achieved.

### Technical Solutions and Advantageous Effects of the Invention

The specific examples below describe a fixing bracket and method for a faucet on a countertop in an aircraft, but the present invention is not limited to fixing a faucet. The present invention discloses a universal fixing system which can possibly be in the form of a universal mounting bracket for any other device or equipment (e. g. a soap dispenser) inside a structure such as, for example, an airplane. The invention also discloses a corresponding method connecting a bracket to a structure and to a device.

The present invention is also not limited to a countertop in a lavatory module. The fixing system and/or method of the present invention can be used in any other structural environment, for example, galleys or cabin dividers.

In order to solve the above stated technical problems, a fixing system according to the invention provides a bracket as disclosed in claim 1 and a method how to install a bracket of the present invention according to claim 10. Preferred embodiments are disclosed in the dependent claims.

According to the invention, a bracket for connecting a device to a structure comprises at least one first fixing means that is configured to fix the bracket to the structure.

The shape of the bracket is not specifically limited and can be circular, elliptical, triangular, free-shaped, rectangular, square or any other suitable shape as long as the bracket can fit into a hole in the structure.

Further, the at least one first fixing means is not specifically limited as long as the at least one first fixing means can achieve two predetermined positions and the distance in a direction perpendicular to the outline of the bracket between the bracket and at least part of the at least one first fixing means can be adapted. In the first position, the at least one first fixing means is located within the outline of the bracket so that the bracket can be inserted into the hole of the structure from the front side of the structure. In the second position, the at least one first fixing means is located outside the outline of the bracket at least partially so that the bracket cannot fit through the hole of the structure and can be fixed to the structure from the back side of the structure.

In the second predetermined position, the bracket can be fixed to the structure.

Further, the at least one first fixing means can be used for structures of different thickness. The at least one first fixing means is capable of varying in distance in a direction perpendicular to the outline of the bracket and the part of the at least one first fixing means that can be located within and outside the outline of the bracket can be fixed at a varying distance depending on the thickness of the structure.

This can be achieved with a threaded screw or a bolt or any equivalent means that can achieve an equivalent effect.

One possibility to implement the at least one first fixing member is through the features of at least one lock wing, at least one fixing screw and at least one stop rib.

The at least one fixing screw is connected to the at least one lock wing. The at least one stop rib is configured to limit the movement of the at least one lock wing at a predetermined position so that the at least one first fixing means is located outside the outline of the bracket at least partially.

The at least one lock wing can move from a first position within the outline of the bracket to a second position where the at least one lock wing is located outside the outline of the bracket at least partially when the at least one fixing screw is rotated in a closing direction, which may be a clockwise rotation or a counterclockwise rotation. The opening direction is, subsequently, a counterclockwise rotation or a clockwise rotation, respectively.

Further, the at least one fixing screw can be reached from the front side of the structure and rotated with a suitable tool such as a screwdriver to tighten and loosen the bracket from the structure via the movement of the at least one lock wing. Through the at least one fixing screw the at least one lock wing can be moved in the direction perpendicular to the outline of the bracket.

By rotating the at least one fixing screw, the at least one lock wing can start to rotate. The at least one fixing screw may be not parallel, but inclined and/or turned outwards to a direction perpendicular to the outline of the bracket but it is also possible to have the at least one screw to be parallel to the direction perpendicular to the outline of the bracket. It is also possible that two, three, four, five, six or more fixing screws are present. In case there are two or more screws, two or more fixing screws can be parallel to each other and/or two or more screws can be inclined to each other. The inclination of the at least one screw allows better access to the screwhead with a corresponding tool and impedes that the diameter of the bracket will be unnecessarily increased.

The at least one stop rib prevents that the at least one lock wing can rotate too far and limits the rotational movement of the at least one lock wing to a predetermined position so that the at least one lock wing is located outside the outline of the bracket at least partially. When the at least one lock wing touches the at least one stop rib, the at least one lock wing cannot rotate anymore but the at least one screw can continue to turn into the thread of the at least one lock wing, so the at least one lock wing will come closer to the back side of the structure until the bracket is completely fixed to the structure independent of the thickness of the structure.

Due to the predetermined length of the at least one fixing screw, the at least one lock wing can be located at a varying distance to the bracket and the bracket can be fixed to a structure of different thickness up to the length of the at least one fixing screw.

Therefore, the bracket of the present invention can be fixed to a variety of structures with a variety of different thicknesses.

The thickness of the structure could also vary as the at least one lock wing can adapt to different thicknesses within one structure.

The bracket further comprises at least one second fixing means configured to fix the device to the bracket.

While the bracket can be fixed to the structure as described above through the at least one first fixing means, the equipment can be fixed to the bracket with the at least one second fixing means.

The at least one second fixing means is not particularly limited as long as it can stably fix the equipment to the bracket.

Hereby, the design of the bracket allows the bracket to enclose the outside wall of the equipment and take up the loads of the equipment.

Therefore, the structural requirements for fixing the equipment to the bracket are greatly reduced, which makes the fixation of an equipment much easier and more stable.

One possibility to fix the equipment to the bracket is by a screw. Hereby, only one single screw is sufficient for achieving a fast and stable fixation—contrary to the prior art as explained above (FIGS. 10 and 11). The one fixing screw presses a locking bolt upwards. The locking bolt is guided in the bracket. The locking bolt can secure the equipment on the top side of the bracket.

Hereby, the bracket is located in one single hole of sufficient and respective dimensions in the structure. With such a hole all other holes and an individual hole pattern in the structure become obsolete and can be omitted in the structure.

Such a single hole of respective dimensions also allows to use the space behind the structure, which is not possible when the various supply lines are placed through a plurality of individual smaller holes through a structure with an individual hole pattern.

There may also be an additional cutout in the hole of the structure fitting to an optional protrusion of the bracket. This optional protrusion in the bracket and its relating additional cutout in the structure can have a centering feature for the bracket and may also prevent rotation of the bracket.

There may also be alternative ways to implement an optional centering feature that is configured to establish a centering between the structure and the bracket, respectively. The implementation of such a centering feature is not limited as long as a centering can be achieved.

For example, it is also possible to implement at least one flattened area in the hole of the structure part, where the bracket can be propped with at least two ribs or at least one flat surface of the bracket.

The optional protrusion of the bracket may be located on the top of the structure or may be located at any suitable position around the structure.

This additional cutout should relate to the position of the optional protrusion.

The bracket further may comprise at least one connector configured to connect at least one supply to the bracket. The supply can be at least one hydraulic pipe and/or at least one electrical wire and/or a tube or wire to supply the equipment with the necessary commodity such as water, current or soap.

In addition, the supply such as, for example, at least one hydraulic pipe and/or at least one electrical wire can be connected to the at least one connector.

Through the disclosure of the present invention, the crucial difference of this solution of the present invention over solutions known from the prior art is that the fixation of the bracket is completely moved to the backside of the structure. In the solutions known from the prior art the fixation is on the front side. This allows implementation of at least one supply, for example at least one hydraulic interface and/or at least one electrical connector inside the bracket, for example one hydraulic interface and one electric connector and therefore more space inside the equipment for other features is realized.

### DESCRIPTION OF THE DRAWINGS

FIG. 1 shows a countertop with a hole as one possible example for a structure to be connected to an environment with a fixing system of the present invention such as a bracket.

FIG. 2 shows a bracket according to an embodiment of the present invention where exemplarily two hydraulic connections and one electric connection are connected to the bracket as well as an exemplarily countertop.

FIG. 3 shows a front view of a bracket according to the embodiment shown in FIG. 2.

FIG. 4 shows a cross-sectional view of a bracket according to the embodiment shown in FIG. 2.

FIGS. 5a, 5b show a rotation of exemplarily two lock wings in the bracket shown in FIG. 2 in a first position and a second position in a front view (left) and a side view (right).

FIG. 6 shows a cross-sectional view section through the bracket shown in FIG. 2 and a faucet.

FIG. 7 shows one example of a fixation of a faucet to the bracket shown in FIG. 2.

FIG. 8 shows a lateral cross-sectional view of a bracket shown with the faucet in FIG. 7 fixed thereto,

FIG. 9 shows an exploded view of an assembly comprising a bracket shown in FIG. 2.

FIG. 10 shows a first mounting concept of the prior art.

FIG. 11 shows a second mounting concept of the prior art.

### DETAILED DESCRIPTION OF THE DRAWINGS

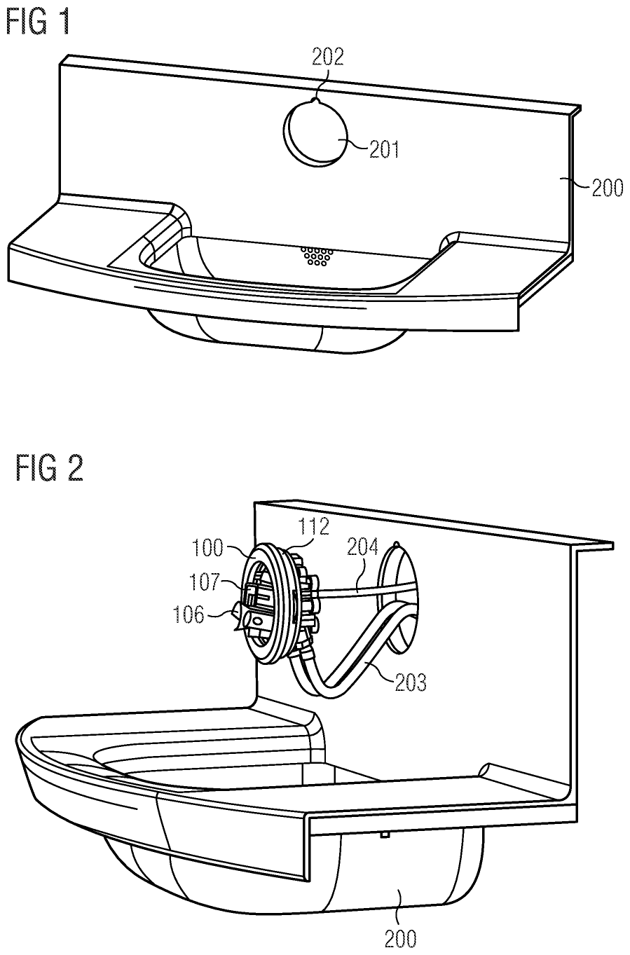

In order to solve the technical problems, in a method according to the present invention one single hole 201 of sufficient and respective dimensions can be drilled in a structure, for example, a countertop 200 in an aircraft cabin, to which a device or an equipment, for example, a faucet, can be fixed. FIG. 1 shows a countertop 200 as one possible example for a structure to which the fixing system can be applied to.

The present invention relates to a fixing system that can fix the equipment to the structure as well as a method for fixing the equipment to the structure with the fixing system. One example for the fixing system, as illustrated in FIGS. 2-9, may be a bracket.

In the example of the countertop 200 as a structure shown in FIG. 1, the diameter of the hole 201 in the countertop 200 may be 68 mm. Contrary to the prior art approach with smaller sized holes at a specific pattern, according to the present invention there is provided only one single sufficiently dimensioned hole. This sufficiently dimensioned hole also allows to use the space behind the structure such as a countertop 200.

There may also be a cutout 202 at the outline of the hole 201 of the countertop 200 in order to have an optional centering feature for a bracket 100 which may also prevent rotation of the bracket 100. This cutout 202 may be round, rectangular, triangular, free-shaped or a further shape to allow the centering of the bracket 100.

In FIG. 2, as one possible example for an at least one supply, it is shown two of the at least one hydraulic pipe 203 and one of the at least one electrical wire 204, which can be pulled through the hole 201 and fixed to the bracket 100. Afterwards the bracket 100 can be placed in the hole 201 of the countertop 200.

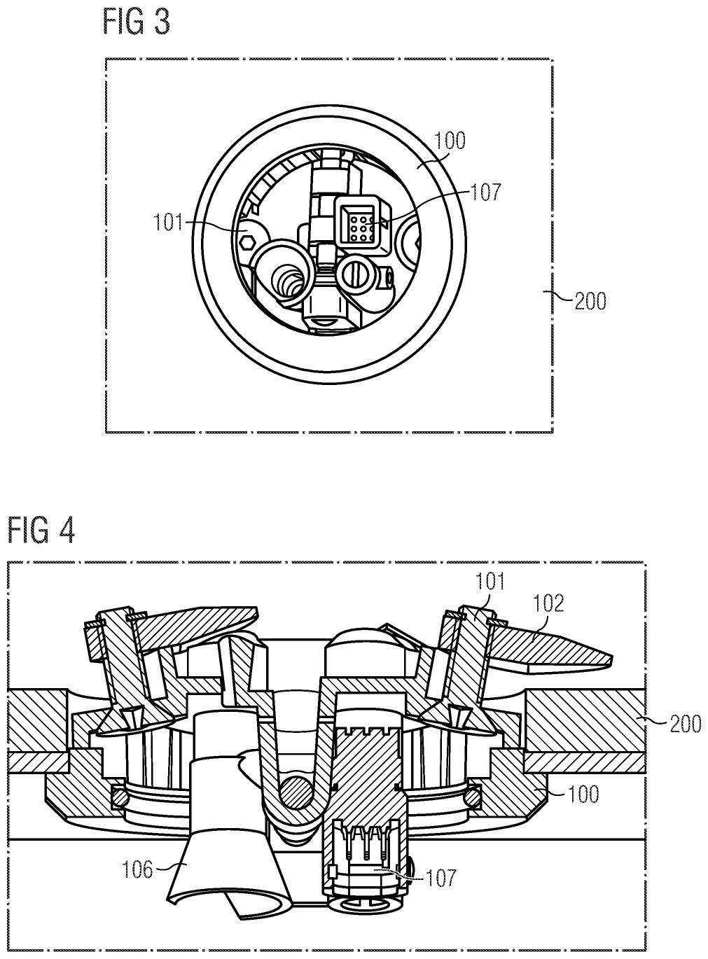

By rotating at least one fixing screw 101 (FIG. 3 shows the view with two fixing screws 101 in an axis direction of the left screw 101), at least one lock wing 102 will start to rotate. In this exemplary embodiment of the present invention, the fixing screws 101 are not parallel, but turned outwards, as shown in FIG. 4, but it is also possible to have fixing screws 101, which are parallel to each other and/or parallel to the direction perpendicular to the outline of the bracket 100. The inclination of the fixing screws 101 allows simplified access to the screwhead of the fixing screws 101 with a corresponding tool and impedes that the diameter of the bracket 100 will be unnecessarily increased.

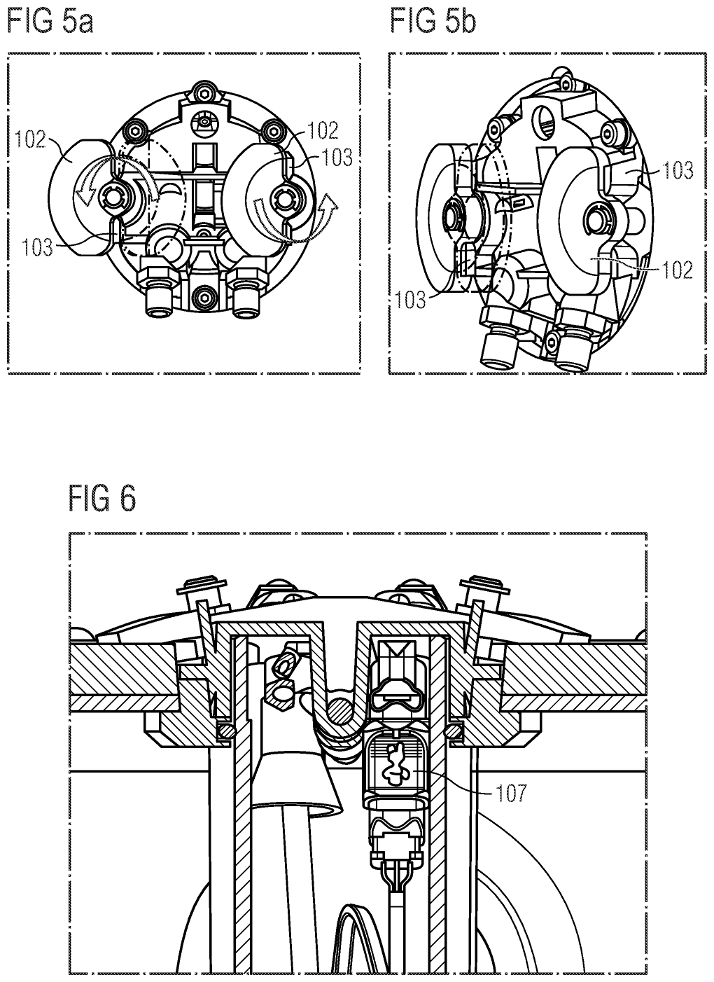

In FIGS. 5a-b, at least one stop rib 103 is shown. This at least one stop rib 103 prevents the at least one lock wing 102 from rotating too far. When the at least one lock wing 102 touches the at least one stop rib 103, the at least one lock wing 102 cannot rotate anymore.

Nevertheless, the at least one fixing screw 101 continues to turn into the thread of the at least one lock wing 102, so the at least one lock wing 102 will continuously come closer to the back side of the countertop 200 until the bracket 100 is completely fixed to the countertop 200.

In the present invention, the difference of the solution compared to other solutions in the prior art is that the fixation of the bracket 100 is completely moved to the back side of the countertop 200. In the solutions of the prior art the fixation is on the front side. This allows to implement at least one hydraulic connector 106 and/or at least one electrical connector 107 inside the bracket 100 of the present invention and therefore more space inside the faucet 205 for other features is realized.

The bracket 100 may, further, have a protrusion 112 that may fit into the cutout 202 of the countertop 200.

After the bracket 100 is installed, the at least one electrical connector of the faucet 205 needs to be connected manually to the bracket 100. Afterwards the faucet 205 will be placed into the bracket 100. The design of the bracket 100 allows the bracket 100 to enclose the outside wall of the faucet 205 and take up the loads of the faucet 205 (FIG. 6).

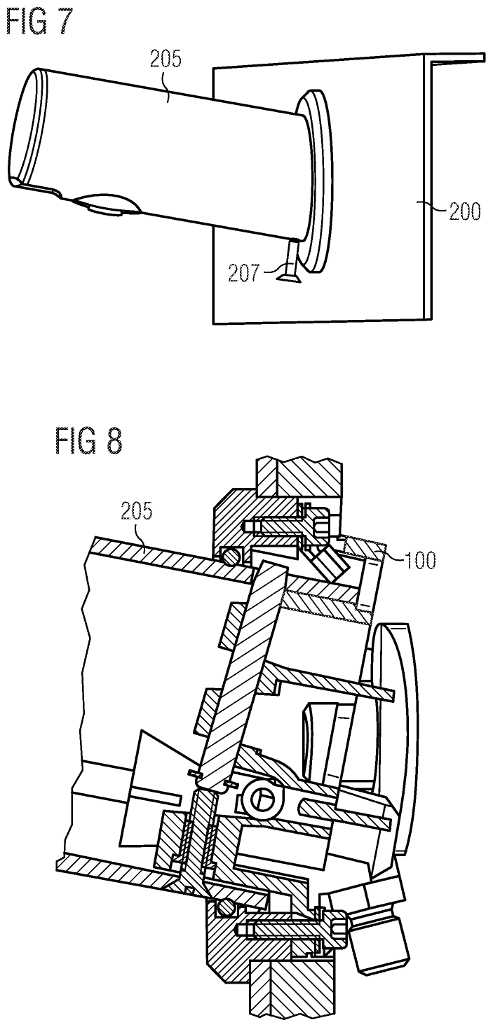

Thereafter the faucet 205 can be fixed with only one single screw 207 (FIG. 7). The one fixing screw 207 of this specific example presses a locking bolt upwards. The locking bolt 105 can be guided in the bracket 100 and can secure the faucet 205 on the top side (FIG. 8). In all faucets of the prior art, there are at least two visible fixing screws required. Every visible screw is a disadvantage, as it has to be sealed and it makes the faucet more difficult to clean as well as susceptible for pollutants.

The exemplary features how the concept of the present invention could be implemented is shown for two lock wings 102, two fixing screws 101, two stop ribs 103, two connectors 106 for two hydraulic pipes and one connector 107 for one electrical wire in the FIGS. 2-9. However, the number of the lock wings 102 and the fixing screws 101 can be one, two, three, four, five, six or any other number as long as the number corresponds to each of those features. Thus, each lock wing 102 is connected to one fixing screw 101. Hereby, the number of lock wings 102 can be the same or less as the number of fixing screws 101. When the number of lock wings 102 is the same as the number of fixing screws 101, each lock wing 102 can be connected to one corresponding fixing screw 101. When the number of lock wings 102 is less than the number of fixing screws 101, one or more lock wings 102 can be connected to one fixing screw 101.

Further, the number of stop ribs 103 can be one, two, three, four, five, six or any other number as long as each lock wing 102 can have a first position and a second position as described above.

The number of the stop ribs 103 does not have to be the same as the number of the lock wings 102 and the fixing screws 101. Each stop rib 103 can be configured to limit the rotation of one or more lock wings 102.

Further, the number of connectors 106, 107 can be one, two, three, four, five, six or any other number, respectively, to provide as many connectors as necessary.

Furthermore, the example shows an inclined faucet 205 in FIGS. 7 and 8, but the present invention is not limited to any inclination or any definite angle. The angle between the equipment and the structural environment can have an arbitrary value as it is suitable for the use of the equipment.

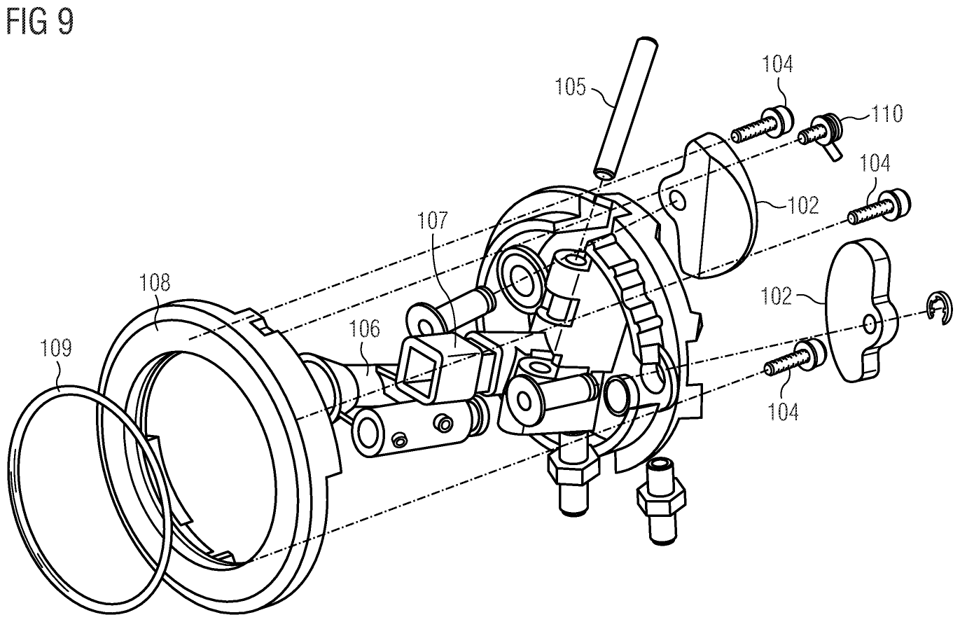

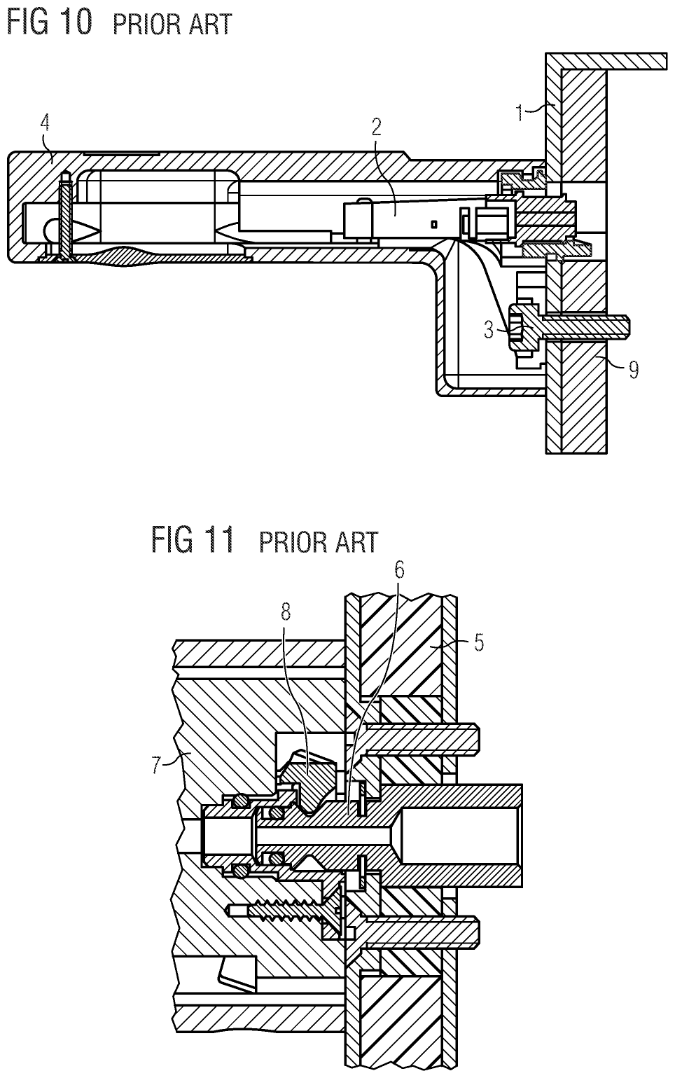

In addition, FIG. 9 shows a specific exemplary assembly comprising a bracket of one embodiment of the present invention. This bracket comprises two lock wings 102, two fixing screws 101, a locking bolt 105, a hydraulic connector 106 and an electrical connector 107. However, as stated above the number of all of these features can vary in the present invention depending on the needs of the device or equipment and the structural restrictions. FIG. 9 additionally shows optional features, which may be included in an assembly. A cover and an O-ring may be connected to the bracket through bonding screws 110. Alternatively, a cover and/or an O-ring may be integrated and/or integrally connected to the bracket.

The essential elements of a universal mounting bracket of the present invention are:
At least one lock wing to install the bracket independently from the wall thickness of the structure.
Independence from structurally pre-defined interfaces.
Numerous electrical and hydraulical interfaces can be integrated in the bracket.
Independence of the mounting bracket from the equipment part.
Mounting from the front side without visible fixing points.
Fixation on the back side of a structural environment.
Possibility of fixing an equipment in several different structural environments independent of the thickness and pre-defined interfaces.
No visible fixing screws which need to be covered and/or sealed.
The hydraulic connections and the electrical connections as well as the fastening of the equipment are integrated in the bracket, which reduces the size of the equipment.
Quick installation and de-installation of the equipment.
Improved finishing and appearance due to one screw fixation of the equipment and less susceptibility for pollution.

### Alternative Embodiments

This invention describes a solution for a fixing system in an aircraft lavatory, but similar devices could be used in other structures for various equipment.

### INDUSTRIAL APPLICABILITY

This invention can be applied in structures in transport vehicles such as, for example, commercial aircrafts.

### LIST OF REFERENCE NUMERALS

bracket 100
fixing screw 101
lock wing 102
stop rib 103
fixing screw 104
locking bolt 105
hydraulic connector 106
electrical connector 107
cover 108
bonding screws 110
hydraulic interface 111
protrusion 112
countertop 200
hole 201
cutout 202
hydraulic pipe 203
electrical wire 204
faucet 205

1. A bracket for connecting a device to a structure, said bracket comprising:
at least one first fixing means comprising at least one fixing screw, at least one lock wing connected to the at least one fixing screw and configured to be rotated by the at least one lock wing, and at least one stop rib configured to limit the movement of the at least one lock wing at a predetermined position, and
at least one second fixing means configured to fix the device to the bracket, wherein the bracket is configured to be located in a hole of the structure.

2. The bracket according to claim 1, further comprising at least one connector configured to connect at least one supply to the bracket.

3. The bracket according to claim 1, wherein the bracket has a protrusion in the radial direction configured to fit into a cutout of the hole of the structure.

4. The bracket according to claim 1, wherein at least one of the at least one fixing screws is inclined and/or turned outwards to a direction perpendicular to the outline of the bracket.

5. The bracket according to any claim 1, wherein at least one of the at least one fixing screws is parallel to a direction perpendicular to the outline of the bracket.

6. The bracket according to claim 1, wherein at least two of the at least two fixing screws are parallel to each other.

7. The bracket according to claim 1, wherein at least two of the fixing screws are inclined to each other.

8. The bracket according to claim 1, wherein at least two fixing screws are inclined to each other and turned outwards.

9. The bracket according to claim 1, wherein the bracket is configured to enclose an outside wall of the device.

10. Method for connecting a bracket to a structure and to a device comprising the steps of:
positioning the bracket in a hole of the structure,
rotating at least one fixing screw connected to at least one lock wing and rotating the at least one lock wing until the rotation of the at least one lock wing is stopped by at least one stop rib, whereby the rotation of the at least one fixing screw moves the at least one lock wing towards the structure from the back side of the structure until the bracket is fixed to the structure.

11. Method according to claim 10, further comprising the step of connecting at least one supply to a connector of the bracket before the step of positioning the bracket in the hole of the structure.
